(19) United States
(12) Patent Application Publication
(10) Pub. No.: US 2007/0057485 A1
(43) Pub. Date: Mar. 15, 2007

(54) Trailer hitch guidance system

(76) Inventor: Christopher P. Lones, Miami, FL (US)

Correspondence Address: Christopher J. Whewell;Western Patent Group, 6020 Tonkowa Trail, Georgetown, TX, 78628, US

(21) Appl. No.: 11/226,594

(22) Filed: Sep. 15, 2005

(51) Int. Cl. B60D 1/07; B60D 1/36

(52) U.S. Cl. 280/416.1; 280/477

(57) ABSTRACT

Provided herein is a system for enabling quick and easy coupling of a motorized vehicle to a trailer or other load that is intended to be pulled or pushed by the motorized vehicle. A system of the invention first provides for gender modification of the trailer to be towed from being female in character, to being male in character. A receiving fixture is configured so as to guide the ball portion of the male-rendered trailer into a receiving hole disposed on the receiving fixture in a locking arrangement which provides increased flexibility in the linkage formed by the elements of this invention, with reduced binding on the hardware during a towing operation. A system according to the invention readily permits a single operator to quickly couple a vehicle to a trailer without additional assistance.

### TECHNICAL FIELD

This invention relates generally to accessories for motorized vehicles and loads which are towed by motorized vehicles, including trailers and like conveyances. It relates more particularly to a system which enables convenient and simple coupling of a motorized vehicle to a wheeled load which is intended to be towed or pulled by the motorized vehicle.

### BACKGROUND

Readily-detachable means for the connection of various wheeled conveyances to a driving vehicle have been known probably for centuries, pre-dating perhaps even the Roman empire, as when carts were drawn by horses. In modern usage, especially following the advent of the automobile, motorized trucks, and the like, it is now commonplace to observe various conveyances being towed by such motorized vehicles at any given time on various national roads. Some common conveyances which are often towed include storage trailers, boat trailers, flatbed work trailers, and livestock transportation trailers, to name but a few.

It is frequently the case that a motorized vehicle which is used to tow a trailer is not solely dedicated to towing a particular trailer, but is desired to be detached from the trailer from time to time in order to enable the vehicle to be used without the trailer attached. Thus, it is of little surprise that the prior art is replete with means for enabling the attachment of trailers to motorized vehicles, a few of which are now briefly mentioned below.

U.S. Pat. No. 929,920 teaches an automatic means for guiding and coupling an engine to a vehicle, comprising: a) a vehicle tongue having bars fastened to the opposite faces thereof and spaced apart and having their free ends flaring at angles to each other; b) a horizontally-disposed pin connecting parallel portions of the bars which project beyond the tongue and adjacent to the angled portions of the bars; c) parallel bars spaced apart, one of which projects beyond the other and bent at an angle; d) a spring-actuated pin supporting member movable between the parallel bars and provided with an elongated slot; and e) a pin normally resting upon the marginal edge of the slot at the end thereof and designed, as the supporting member is moved under the tension of the spring by contact with the horizontally-disposed pin to allow the coupling pin to fall by gravity to a locked position.

U.S. Pat. No. 3,938,122 sets forth a guidance device activated by a power source to aid an operator in the alignment of a first and a second object, at least one of which is movable with respect to the other comprising: a) a flexible line connectable between desired points on the first and second objects; b) a means mounted on the first object for drawing in the line as the first object moves toward the second object; c) a sensing means for detecting changes in the alignment of the desired points; and d) an indicating means for signalling the changes to the operator whereby alignment may be determined and maintained during movement of the first object toward the second object wherein the sensing means includes: i) a frame; ii) a switching element in electrical contact with one pole of the power source; iii) a means for pivotally mounting the element on the frame; and iv) at least three contact points carried by the frame and in electrical contact with the other pole of the power source; and wherein the switching element includes: i) an elongated slot through which a rivet passes to guide reciprocable movement of the element on the frame; ii) at least one gate extending outwardly from the element and having an aperture therein for the passage of the flexible line freely therethrough; and iii) a forward edge communicable with all of the contact points and terminating in a point communicable with any one of the contact points.

U.S. Pat. No. 5,725,232 provides a trailer hitch guide, comprising: a) a V-shaped plate having a pair of angularly-diverging arm panels adapted for mounting upon a draw bar in surrounding relation to a hitch ball carried on the draw bar; b) a pair of resilient pads, with each of the pads, respectively, being secured to one of the arm panels; and c) at least one pair of cooperating, L-shaped flanges affixed one above the other to one of the arm panels for slidably receiving one of the resilient pads therebetween.

U.S. Pat. No. 6,102,422 describes a retractable trailer hitch guide comprising: a) at least one side plate assembly composed of a first and second side plate; the first and second side plate being composed of a first and second side; a first and second yoke guide receiver tube being affixed by means respectively to the first and second side plate; b) a yoke assembly which is composed of a yoke end; a first and second yoke guide which are joined by a bracing means, affixed by means to each of the first and second yoke guides; the first and second yoke guides are sized and received respectively into the first and second yoke guide receiver tubes; c) the first and second side plates are adapted to be fixed to a tongue in an orientation which causes the yoke end to intercept and guide a trailer hitch ball for connection with a trailer hitch assembly.

U.S. Pat. No. 6,222,457 sets forth a vehicle hitching system that comprises: a) an alignment sensor attached to one of either a towing vehicle or a towed vehicle such that an alignment sensor emits a light beam over a field of view; and b) a light reflector attached to the other of the towing vehicle or the towed vehicle at a predetermined location relative to the alignment sensor, whereby the light reflector for reflects a portion of the emitted light beam back along a path that is substantially parallel to the emitted light beam. The alignment sensor emits a first audible alarm in response to detecting the reflected portion of the emitted light beam that is substantially parallel to the emitted light beam and the first audible alarm indicates that the light reflector is within the field of view of the alignment sensor to indicate that the hitch components are moving towards alignment.

U.S. Pat. No. 6,769,709 discloses A trailer hitch alignment system for aligning a vehicle with a gooseneck trailer, wherein the gooseneck trailer has a downwardly-extending hitch assembly for mating with a hitch ball mounted to the vehicle. The vehicle comprises a cab, a truck bed, and a bed box. The system comprises: a) one or more transmitters mounted to the vehicle on an inner portion of the bed box at one or more known positions for transmitting energy toward the downwardly extending hitch assembly; b) a first receiver mounted to the vehicle on an inner portion of the bed box in a known position for receiving a first reflected energy signal from the downwardly extending hitch assembly; c) a second receiver mounted to the vehicle on an inner portion of the bed box in a known position for receiving a second reflected energy signal from downwardly extending hitch assembly; d) a timer for determining a time of travel of the energy from the one or more transmitters to the downwardly extending hitch assembly and to the first receiver and the second receiver; e) a processor connected to the timer for determining a relative position of the downwardly extending hitch assembly with respect to a position of the hitch ball from the time of travel; and f) an indicator for indicating the relative position of the downwardly extending hitch assembly with respect to a position of the hitch ball.

U.S. Pat. No. 6,789,815 teaches an apparatus for securing a hitch to a vehicle, which comprises: a) a mount having longitudinal, lateral, and transverse directions substantially mutually orthogonal to one another, wherein the mount has a platform portion to receive a hitch, and wherein the mount also has a first locking aperture and a second locking aperture formed therein; b) a retainer for selectively retaining an object extending around the hitch, the retainer having a forward end and a rearward end, the forward end pivoting with respect to the mount between a first, retaining position and a second, open position the retainer having at least one opening formed therein; and c) a lock configured to selectively retain the retainer in the first position when the first locking aperture is aligned with the at least one opening or in the second position when the second locking aperture is aligned with the at least one opening.

One important criteria for a coupling from the safety standpoint is that the coupling must not fail while the motorized vehicle is towing a trailer. It has further been found desirable to provide a system which assists the driver of the motorized vehicle to single-handedly couple a trailer to the motorized vehicle. For cases where the on-board vehicle complementary counterpart of the coupling mechanism is in the direct view of the driver, alignment of the coupling mechanisms' counterparts is a straightforward operation, inasmuch as the driver is able to guide the vehicle to a position on the ground with respect to the trailer which enables the coupling counterparts to engage one another, or be within an effective distance from one another to enable coupling by a simple hand operation, such as lowering the ball-receiving coupling counterpart on a trailer with a trailer ball which is connected to the frame of the motorized vehicle.

However, in many instances, the design of the motorized vehicle is such that the counterparts of the coupling mechanism are not within direct view of the driver, such as where an automobile, sport-utility vehicle, pickup truck, or tow truck is used to pull, say, a boat mounted on a trailer. In such instances, the operator of the vehicle needs to be assisted by a second person standing outside who provides verbal or hand signals to the driver indicating which direction the vehicle's travel must be modified in order to make a coupling operation successful. For cases where the driver is acting solo, the act of coupling a trailer to such a vehicle becomes an exercise of trial and error, typically requiring the driver to either get lucky, or else exit the vehicle to inspect the proximity of the coupling counterparts with one another, and climb back aboard the vehicle and make further positional adjustments in the location of the vehicle. Such an exercise is time-consuming and frustrating at times, and also contains an inherent measure of danger associated with driving vehicles in a reverse direction.

The present invention enables a driver to avoid these inconveniences by providing a system which enables a single person to engage the coupling between a vehicle and a trailer in a single-step operation, perfectly, every time.

### SUMMARY OF THE INVENTION

The present invention provides a first component, which is a device useful for coupling a motorized vehicle to a trailer which comprises: A) a receiving portion comprising: a) a floor portion having: i) a trailer-receiving edge; ii) a second edge; and iii) a third edge; b) a first wall portion having a proximal end and a distal end and a height dimension and being disposed along the length of the second edge of the floor portion, extending perpendicularly upwards from the floor portion; c) a second wall portion having a proximal end and a distal end and a height dimension, and being disposed along the length of the third edge of the floor portion, extending perpendicularly upwards from the floor portion; d) a hole disposed in the floor portion in the proximity of the point where the second edge intersects the third edge, wherein the hole is adapted to receive a trailer ball; and B) a tow bar. The tow bar is attached to the receiving portion.

Also provided is a second component which comprises a device useful for altering the gender of a trailer hitch which comprises: a) a first ball portion existing substantially in the shape of a sphere and having a first bore hole having an inner wall and extending at least partially therethrough, the first bore including threads on its inner wall; b) a second ball portion existing substantially in the shape of a sphere and having a second bore hole having an inner wall and extending at least partially therethrough, the second bore including threads on its inner wall; c) a rod having a first end which includes threads on its outer surface and a second end which includes threads on its outer surface, and an outer diameter; d) a strike plate, comprising a substantially planar sheet metal, further comprising a hole disposed through its entirety having a diameter that is large enough to enable the rod to pass therethrough; and e) a nut having a threaded bore capable of cooperative disposition on the rod. The first ball portion is disposed on the first end of the rod and the second ball portion is disposed on the second end of the rod by cooperation of the threads disposed on the rod ends and threads disposed within the bores within the ball portions. The strike plate is disposed on the rod at a location between the first ball portion and the second ball portion. The nut is disposed on the rod at a location between either of the ball portions and the strike plate.

The first component and second component are used together. The first component is used to provide a motorized vehicle comprising the first component, which may cooperatively function with a gender-modified trailer, which gender-modified trailer comprises a conventional trailer having a “female” ball-receiving socket, that further comprises a device according to the second component with either of said first ball portion or said second ball portion being disposed in said ball-receiving socket, and the remaining ball portion being disposed beneath said socket.

### BRIEF DESCRIPTION OF THE DRAWINGS

In the annexed drawings,

FIG. 1 shows a perspective view of a coupling means between a motorized vehicle and a trailer according to the prior art;

FIG. 2 shows a side exploded view of a gender-altering assembly component of a system according to the present invention;

FIG. 3 shows a side view of an assembled gender-altering assembly component of a system according to the present invention;

FIG. 4 shows a conventional trailer which is fitted with a gender-altering assembly component of a system according to the present invention;

FIG. 5 shows a trailer-receiving attachment according to the present invention;

FIG. 6 shows a side view of a trailer-receiving attachment according to the present invention;

FIG. 7A shows a conventional trailer which is fitted with a gender-altering assembly component of a system according to the present invention as it is approached by a trailer-receiving attachment according to the present invention;

FIG. 7B shows a conventional trailer which is fitted with a gender-altering assembly component of a system according to the present invention in contact with a trailer-receiving attachment according to the present invention;

FIG. 7C shows a conventional trailer which is fitted with a gender-altering assembly component of a system according to the present invention cooperatively engaged with a trailer-receiving attachment according to the present invention;

FIG. 8 shows a perspective view of a coupling means according to one embodiment of the invention;

FIG. 9A shows a side view of a section of a portion of a coupling means according to the invention;

FIG. 9B shows a perspective view of a section of a portion of a coupling means according to the invention;

FIG. 10 shows an exploded view of a gender-altering assembly according to an alternate form of the invention;

FIG. 11 shows an overhead view of a gender-altering assembly according to an alternate form of the invention with a trailer frame attached;

FIG. 12 shows a frontal end view of a gender-altering assembly according to an alternate form of the invention with a trailer frame attached;

FIG. 13 shows a right-side elevation view of a gender-altering assembly according to an alternate form of the invention with a trailer frame attached;

FIG. 14 shows an underside perspective view of a gender-altering assembly according to an alternate form of the invention from the left side; and

FIG. 15 shows an underside view of a gender-altering assembly according to an alternate form of the invention.

### DETAILED DESCRIPTION

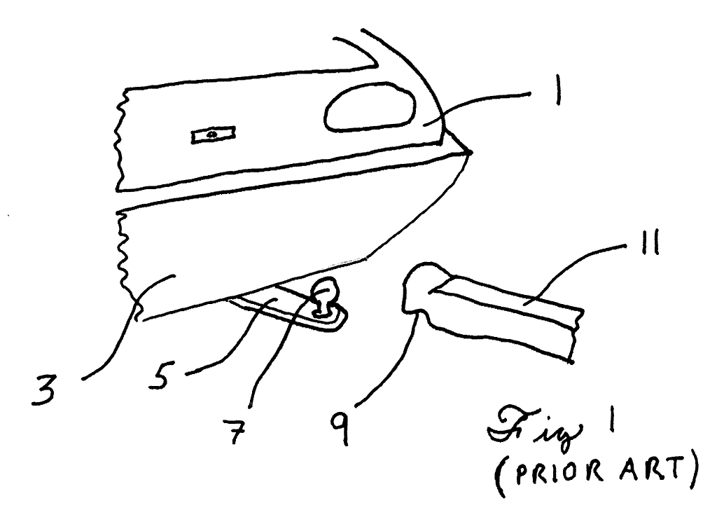

Referring to the drawings and initially to FIG. 1 there is shown a perspective view of a coupling means between a motorized vehicle and a trailer according to the prior art. In this FIG. 1 are shown a motorized vehicle 1, which may be an automobile, truck, tractor, etc., having a bumper 3, and a hitch tongue 5 which is rigidly affixed to the motorized vehicle 1, typically to the vehicle's frame (not shown). The hitch tongue 5 includes a conventional ball 7 disposed at its distal end portion. There is also shown a trailer frame 11, having a socket 9 at its distal end, which socket 9 is contoured so as to be able to receive the conventional ball 7 in a locking engagement, which enables a vehicle and trailer connected thereby to swivel about the junction formed by the conventional ball 7 and socket 9, such as when the motorized vehicle 1 makes a turn during a change in its direction of travel.

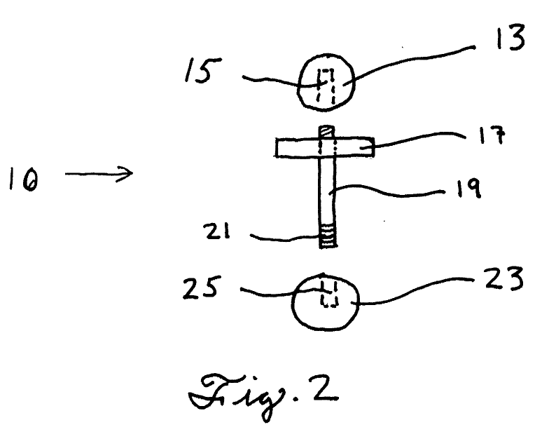

In FIG. 2 is shown a side exploded view of a gender-altering assembly 10 component of a system according to the present invention. In this figure there is a first ball 13 having a bore 15, a rod means 19 having a threaded end portion 21, a strike plate 17, a second ball 23 having a bore 25 disposed partially therethrough. The bore 15 through the first ball 13 preferably extends only partially into said ball 13, such as about halfway through, and in one preferred embodiment includes threads on the inner wall of the bore 15 which cooperatively engage with threads on the end portion of rod means 19. In one embodiment, the rod means 19 is threaded along its entire length. In another embodiment, the rod means only includes threads on its end portions. The second ball 23 is similarly configured to the first ball 13 in that it's bore 25 extends preferably partially through said ball 23 and includes threads on its inner wall. Such an arrangement enables the first ball 13 and the second ball 23 to both simultaneously be threaded onto the end portions of the rod means. Further inclusion of a strike plate 17, which is a piece of sheet metal having any shape including without limitation rectangular, square, circular, etc., which has a hole disposed through it so as to enable the rod means 19 to pass through the strike plate 17. Preferably, the hole in the strike plate 17 is just slightly larger than the outside diameter of the rod means 19. Thus, the assembled form of the gender-altering assembly 10 comprises a rod having at least threaded end portions, each of which have a ball threaded thereto, with a strike plate being disposed between the balls such that the centerline of the hole is oriented substantially parallel to the length dimension of the rod means 19. The strike plate 17 may also have one (or more) wall portion(s) extending upwardly around its perimeter, just as the first component. In one embodiment, the strike plate 17 is substantially circular as viewed from above. In another embodiment, the strike plate 17 is substantially rectangular as viewed from above. In another embodiment, the strike plate 17 is substantially square as viewed from above. Such a configuration as that described above enables a person to insert one of the ball portions of the second component into a conventional ball-receiving socket of a trailer, lock the coupler latch, and subsequently tighten the nut against the strike plate 17 so that the strike plate 17 is in firm contact with the underside of the portion of the conventional ball-receiving trailer which it is able to contact.

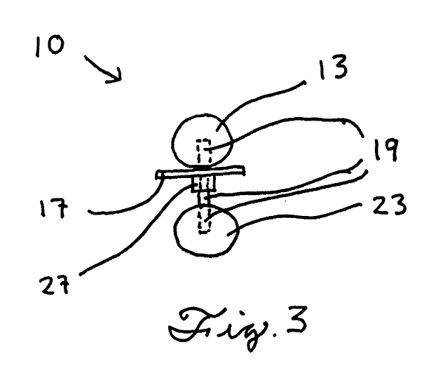

FIG. 3 further shows a side view of an assembled gender-altering assembly 10 component of a system according to the present invention, which further includes a threaded nut 27 disposed along the rod means 19, wherein the rod means 19 includes threads along its entire outer surface. Under such an arrangement, the nut may be tightened against the strike plate 17 so as to force the strike plate 17 to rigidly contact the first ball 13, which is itself (as well as the second ball 23) attached to the end of the threaded rod means 19 by the threads within its bore being engaged to the threads on the rod means 19.

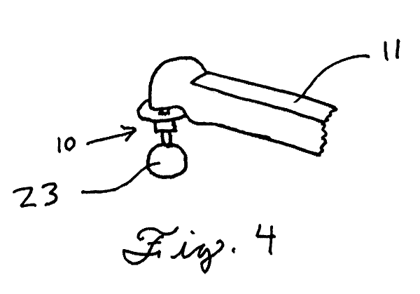

A gender-altering assembly 10 such as that shown in FIG. 3 may be inserted into the socket portion 9 located at the distal end of a conventional trailer frame 11, as depicted in FIG. 4. Such a provision causes the “gender” of a conventional trailer to be converted from being “female” in gender, to take on the trait of being “male” within the context of trailer hitch assemblies.

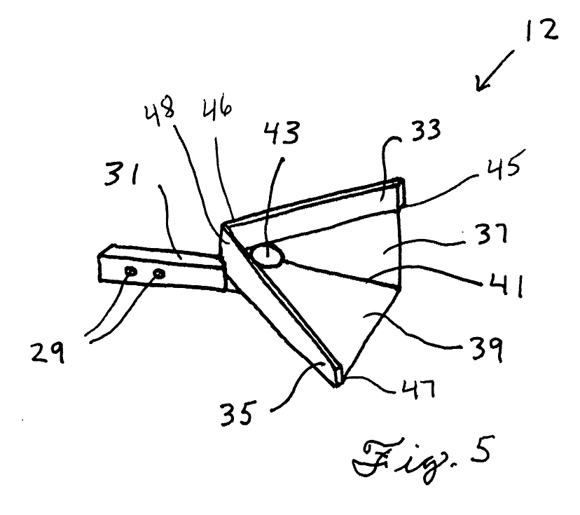

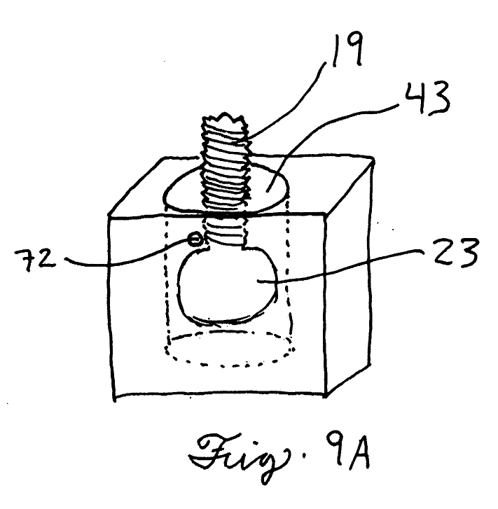

In FIG. 5 is shown a trailer-receiving attachment 12 according to the present invention, which includes a tow bar 31 having optional adjustment holes 29 disposed through its length. The trailer-receiving attachment 12 in one embodiment comprises a first floor portion 37 and a second floor portion 39, which in one preferred form of the invention intersect at a partition 41, which partition 41 is merely a line of intersection between the first and second floor portions by virtue of their being disposed in different physical planes. In an alternative embodiment, both the first floor portion 37 and second floor portion 39 exist in the same physical plane and there is no partition 41, and such floor portion 112 is shown in FIG. 8. When the first floor portion 37 and the second floor portion 39 do not exist in the same plane, the first floor portion 37 may herein be alternatively considered as the first sub-floor portion, and the second floor portion 39 may alternatively be considered as a second sub-floor portion. It is however advantageous that the first floor portion 37 and second floor portion 39 are not in the same plane. The first floor portion 37 and second floor portion 39 collectively are configured to exist roughly in the shape of a triangle as viewed from above. There is a first wall portion 33 attached to the first floor portion 37 substantially perpendicularly along one of its edges. There is a second wall portion 35 attached to the second floor portion 38 substantially perpendicularly along one of its edges. The first wall portion 33 has a proximal end 45 and a distal end 46. The second wall portion 35 has a proximal end 47 and a distal end 48. Preferably, the first wall portion 33 and second wall portion 35 extend upwards (walls height dimension) from the floor portions to which they are attached/adjacent an amount between about 1 inch and 6 inches, with a preferred height dimension of about 1.5 inches. In a preferred embodiment, the height dimensions of the first wall portion 33 and the second wall portion 35 are the same. In one embodiment, the distal ends of the first and second wall portions intersect to form an angle, which angle may be any angle in the range of between about 45 degrees and 135 degrees, but is preferably about 90 degrees. In another embodiment, the distal ends of the first and second wall portions do not contact one another, such as when the distal ends are truncated. In a preferred embodiment, the location at which the first floor portion 37 contacts the proximal end 45 of the first wall portion 33 is at a higher elevation than the partition 41, and the location at which the second floor portion 39 contacts the proximal end 47 of the second wall portion 35 is at a higher physical elevation than the partition 41. Under such an arrangement, a valley is formed by the two floor portions, which valley has its lowermost points residing along the partition 41.

The trailer-receiving attachment 12 also includes a hole 43 which is disposed in the vicinity of the point at which the length dimensions of the first wall portion 33 and second wall portion 35 intersect. This hole 43 is dimensioned such that it is able to receive the second ball 23 of a trailer hitch such as that shown in FIG. 4 which is equipped with a gender-altering assembly 10 as hereinbefore described. The assembly which comprises the first and second floor portions and the first and second wall portions is attached to the tow bar 31 by conventional means, such as welding. In one embodiment, one or more of the floor portions 37, 39 are welded to the tow bar 31.

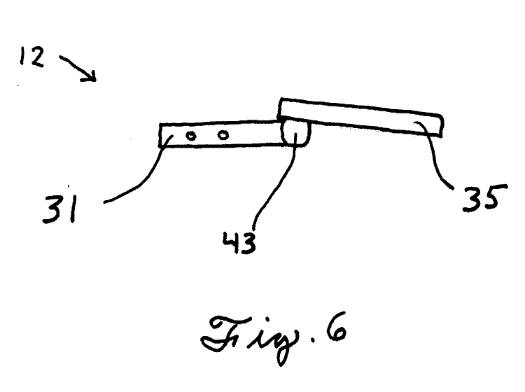

FIG. 6 shows a side view of a trailer-receiving attachment according to the present invention, showing the respective locations of the second wall portion 35, hole 43, and tow bar 31. In one embodiment, the hole 43 may include a liner, which essentially consists of a metal cup of cylindrical dimension which is attached to the underside of the floor portions along the circumference of the hole 43 from FIG. 5, so as to form a construct or lining which is reminiscent of a golf hole. Thus, the hole 43 is preferably provided with a lining.

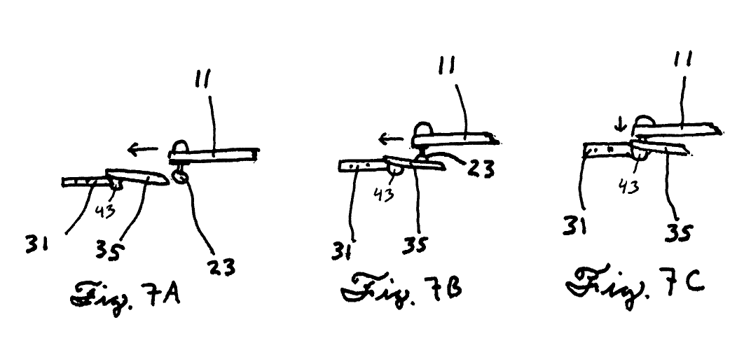

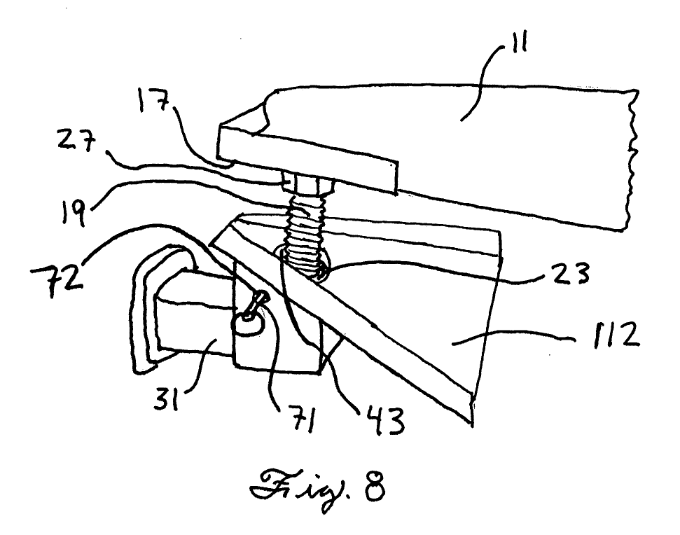

FIG. 7A shows a conventional trailer which is fitted with a gender-altering assembly 10 component of a system according to the present invention as it is approached by a trailer-receiving attachment according to the present invention. In FIG. 7B there is shown a conventional trailer which is fitted with a gender-altering assembly component 10 of a system according to the present invention in contact with a trailer-receiving attachment according to the present invention, such as is the case when a vehicle comprising the trailer-receiving attachment is backed up to a trailer which is fitted with the gender-altering assembly 10. FIG. 7C shows a conventional trailer which is fitted with a gender-altering assembly 10 component of a system according to the present invention cooperatively engaged with a trailer-receiving attachment according to the present invention, such as after the vehicle has backed up sufficiently to enable the second ball 23 to engage or reside within the hole 43, thus completing a coupling operation using a system according to this invention.

In a system according to the present invention, the weight of the load being towed essentially presses downward into the hole 43 in the trailer-receiving assembly 12, which is different from that afforded by conventional coupling systems in the prior art, in which the weight of the trailered load presses down on the ball 7 from FIG. 1. Such a provision afforded by the present invention enables greater flexibility of the coupling during a towing operation with less binding forces on the linkage as a whole.

In one preferred embodiment, the first floor portion 37 and second floor portion 39 (or 112, FIG. 8 when the floor portion comprises a single planar surface) are coated with a friction-modifying substance, to permit smooth gliding of the second ball 23 along the collective floor portions during a coupling operation. Such a coating may be a polymeric coating, which is applied to these surfaces after manufacture of the trailer-receiving attachment 12. In alternative embodiments, such a coating may comprise a single sheet of polymer, such as a sheet of polyethylene, polypropylene, or any other commercial thermoset or thermoplastic polymer attached to the floor portion(s) using conventional means such as screws or bolts disposed through the polymer sheet and the floor portions, or by adhesive means, as such are known to those skilled in the art, or through the use of a spray-on coating. This liner of the floor portion in one embodiment is textured and lubricated, using a conventional lubricant, such as an oil, TEFLON® polymers, or other conventional friction-modifying substance. Such provision provides for a smooth coupling transition as a vehicle backs up toward the trailer and the bottom ball 23 easily slides on the liner into the receiving hole 43. The liner prevents metal-to-metal contact, which prolongs the life of the unit as a whole. For purposes of this specification and the claims appended hereto it is convenient to refer to that edge of the first floor portion 37 or the second floor portion 39, either singly or both collectively, which is disposed towards the direction from which a distal end of a trailer fitted with a gender-altering assembly 10 approaches, as the trailer-receiving edge.

During a coupling operation, as shown collectively in FIGS. 7A, 7B, 7C, a vehicle equipped with a trailer-receiving attachment 12 according to the invention is caused to approach a trailer which is equipped with the gender-altering assembly 10. When the second ball contacts either the first floor portion 37 or second floor portion 39, it is caused by the effect of gravity to reside within the valley defined by the partition 41, which partition further guides the second ball 23 right into the hole 43. In the event the driver moves the vehicle quickly, or there is not perfect alignment of the second ball 23 with the partition 41, the second ball 23 will ride along one of the floor portions until the second ball 23 strikes against one of either the first wall portion 33 or second wall portion 35, which wall, by its location, guides the ball 23 to the location of the hole 43 as the vehicle moves towards the trailer. Thus, the present invention makes coupling a trailer to a motorized vehicle a simple, one-person operation.

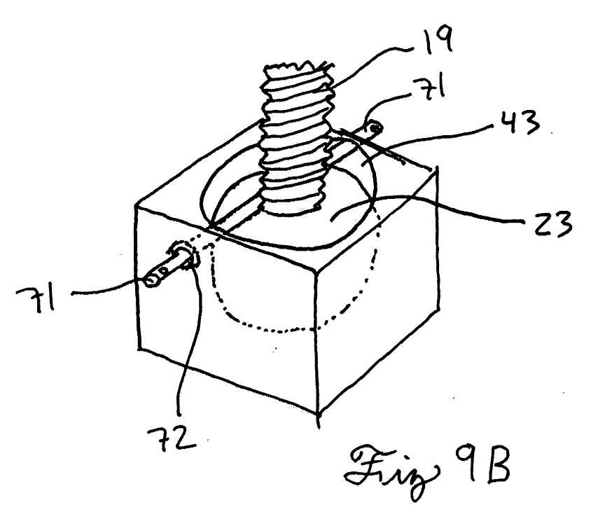

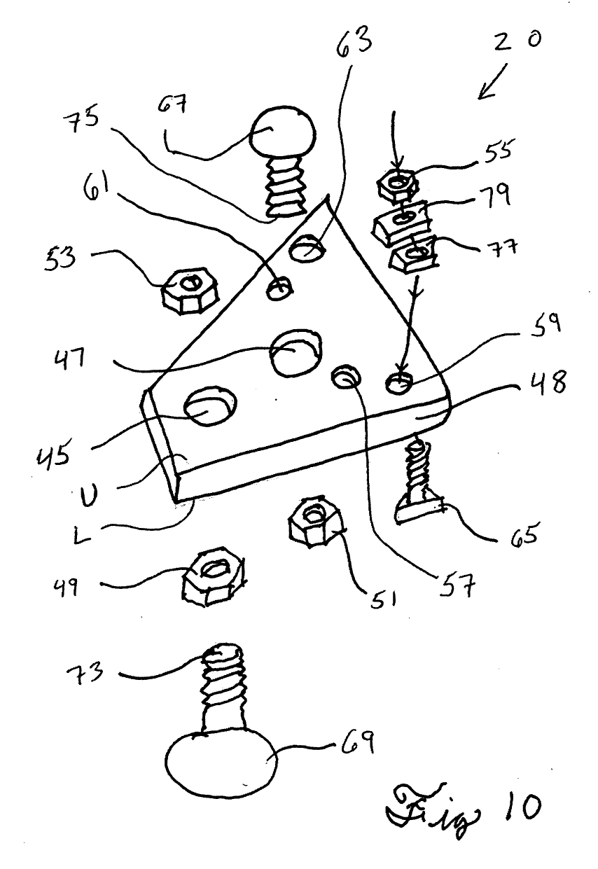

FIG. 8 shows a perspective view of a coupling means according to one embodiment of the invention, showing the ball 23 disposed in the receiving hole. Also shown in this figure is the rod 19, strike plate 17, nut 27, receiving hole 43, tow bar 31, floor portion 112, and trailer frame 11. In this embodiment, the floor portion 112 comprises a single plane. Further shown in this FIG. 8 is a locking pin 71, which resides in a pin hole 72. The purpose of the locking pin is to keep the lower ball 23 in place within the receiving hole 43 while an item is being towed, when the vehicle travels over bumps or other imperfections in a road surface which might otherwise tend to cause the ball 23 to bounce out of the receiving hole 43. The locking pin 71 in this means for securing the trailer is disposed so that its length axis is substantially skew to the length axis of the rod 19. FIG. 9 shows this relationship more clearly as it shows a side view of a section of a portion of a coupling means according to the invention which includes the receiving hole 43. In this FIG. 9A, there is also shown the lower ball, and the pin hole 72. The pin hole is disposed so that a pin placed through it is located above the upper surface of the lower ball 23 when the lower ball 23 is in the receiving hole 43, but between the outer surface of the rod 19 and a line drawn tangent to the ball, which tangent line is also substantially parallel with the long axis of the rod 19, in one embodiment. Such a provision ensures that when the vehicle encounters a bump in the road, the ball 23 cannot pop out of the receiving hole 43 because the locking pin 71 obstructs its travel. The locking pin preferably extends from the exterior of one side surface of the ball-receiving hole 43 to the exterior of a surface located on the opposite side of the ball 23. In one preferred embodiment, the locking pin 71 has holes drilled near both of its end portions, for receiving cotter pins, clips rings or other wares which prevent the locking pin 71 from sliding laterally out of the hole 72. This relationship is more clearly shown in the perspective view in FIG. 9B. Other conventional means for securing a trailer ball in a receiving hole known in the art are suitable for use within the metes and bounds of the present invention.

According to one embodiment, the hole 43 has a diameter having dimension D, and a centerpoint centrally located on this diameter, and the centerpoint of the hole 43 is located at a distance less than about 3D from the point at which the first wall portion and the second wall portion intersect in space.

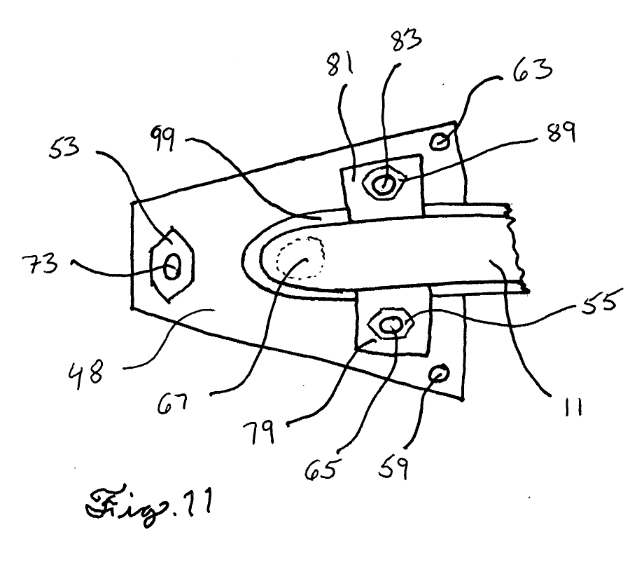

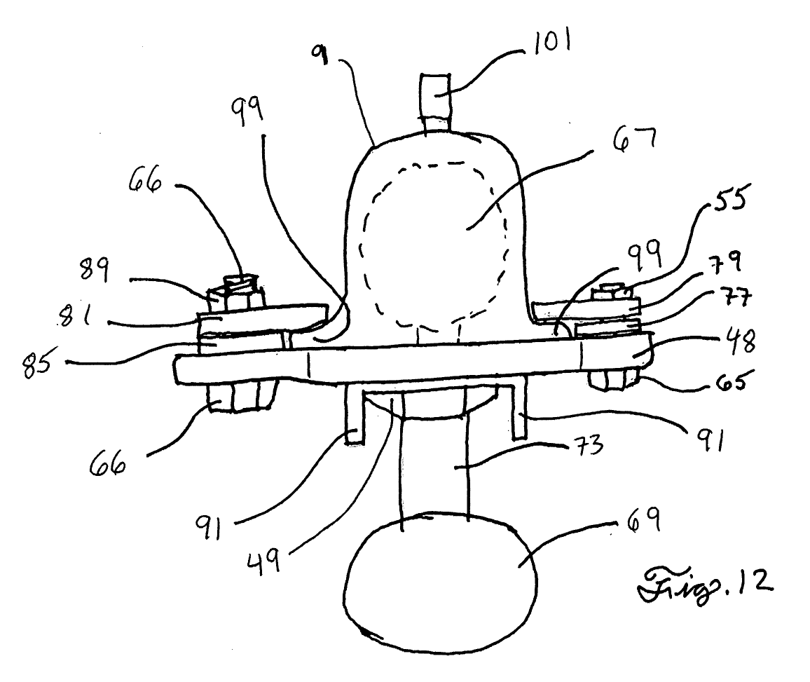

In FIG. 10 shows an exploded view of the components of a gender-altering assembly 20 according to an alternate form of the invention. In this embodiment, there is a plate portion 48 with an upper surface U and a lower surface L, which further comprises holes at 45, 47, 61, 63, 57, and 59 for receiving the remaining elements of the gender-altering assembly 20. Conventionally-sized trailer hitch balls are again employed in this embodiment, with the stud 73 of lower ball 69 being passed through hole 45 and being secured to the plate 48 via the nuts 49 and 53. There is an upper ball 67 with a stud 75, that is passed through hole 47 and secured to the plate 48 via nut 51. Holes 57, 59, 61, and 63 extend through the plate 48 and are collectively adapted to receive a plurality of stabilizing hardware assemblies, which stabilizing hardware assemblies comprise the bolt 65, bracer 77, bracer 79 and nut 55, as shown in the remaining figures herein. The bracers 77, 79, 81 (FIG. 11) are comprised of thick sheet metal stock, preferably steel, which contain a bore therethrough for reasons which shall become apparent. The plate 48 itself is preferably comprised of steel of an appropriate thickness, which is preferably in the range of between about 3 millimeters and 25 millimeters, although any thickness of steel may be employed. Although the plate 48 is depicted as being substantially trapezoidal in shape, in this preferred embodiment, the present invention also includes within its scope plates 48 of other shapes, including without limitation: circular, oval, rectangular, square, oblong, and including irregular shapes.

In FIG. 11 is shown an overhead view of a gender-altering assembly according to an alternate form of the invention with a trailer frame attached. In this view are shown stud 73 of the lower ball 69, secured to the plate 48 via the nut 53. The upper ball 67 is shown in phantom in its position within the socket portion of the trailer frame 11. As is known in the art, the distal portion of the trailer frame 11 often includes a lip portion 99. This lip portion 99 is used to advantage in securing a trailer frame 11 to the gender-altering assembly of this embodiment, by virtue of the braces 79 and 81 acting as clamps atop the lip portion 99, with a clamping force being supplied by the nuts 55 and 89 attached to the studs 65 and 83. Tightening of the nuts 55 and 89 with the braces 79 and 81 in position over the lip 99 of the trailer frame 11 provides a clamping force between the braces and the lip portion. Holes 59 and 63 are not used in this embodiment for securing stabilizing hardware assemblies, since holes 57 and 61 have been used for this purpose. The reason holes 59 and 63 are included, is to enable the movement of the stabilizing hardware assemblies to accommodate different sized widths of trailer frame 11, thus conferring a high degree of universality to the gender-altering assembly of this embodiment concerning the trailer frames it is capable of receiving. The holes 59 and 63 can be disposed essentially anywhere on the plate portion, provided the bracers are suitably dimensioned to enable their appropriate contact with the distal end portion of the trailer frame 11 which contains the socket portion 9.

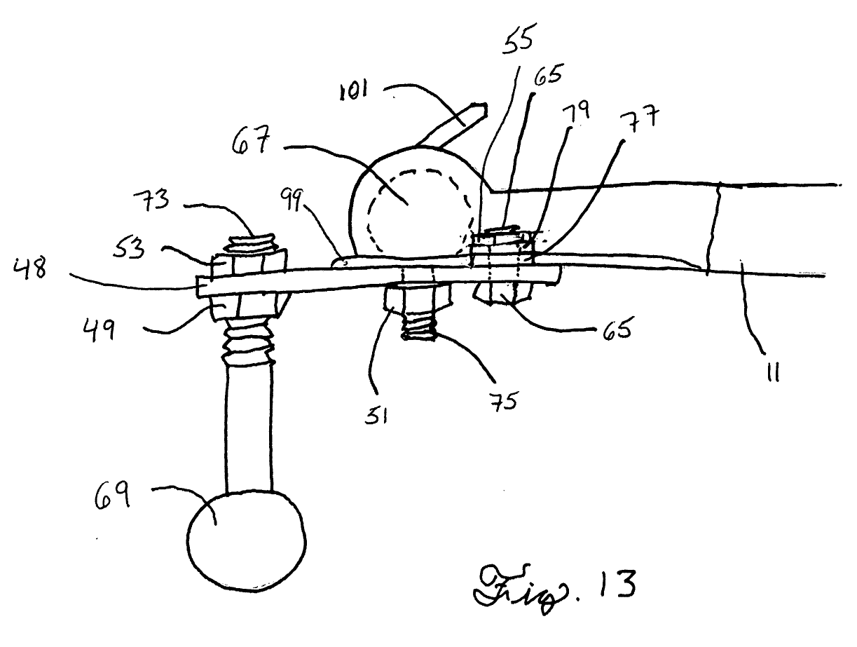

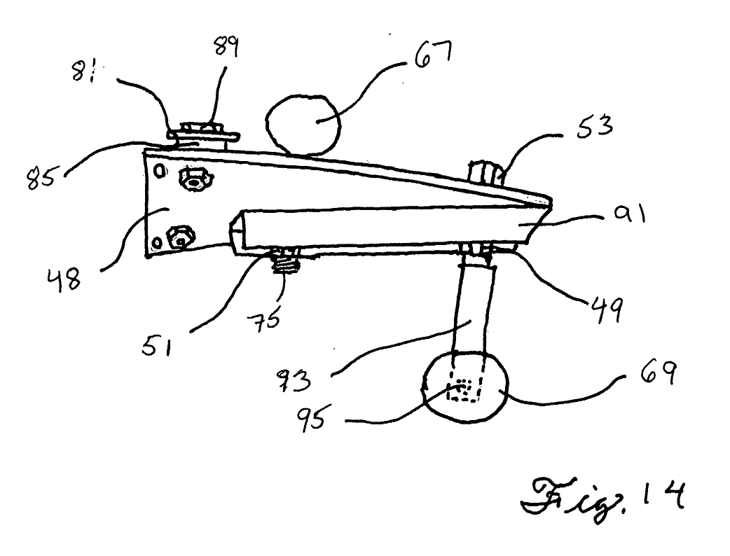

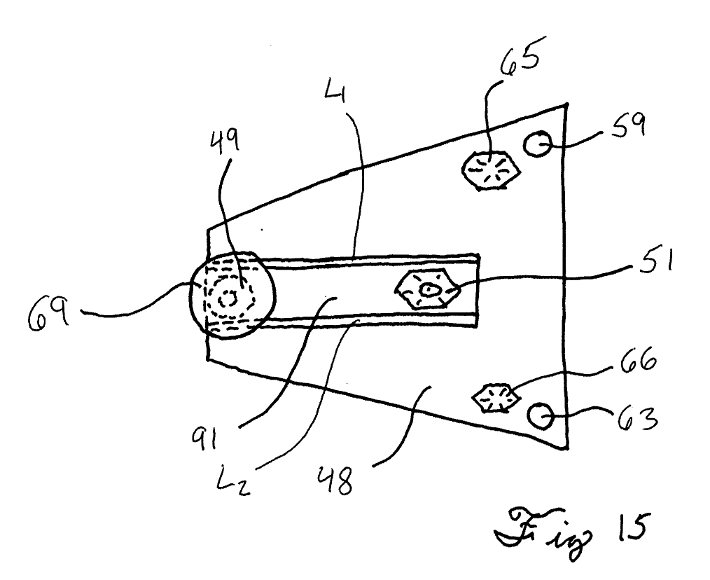

In FIG. 12 is shown a frontal end view of a gender-altering assembly according to an alternate form of the invention, with a trailer frame attached. In this embodiment is shown the plate 48, to which upper ball 67 (shown in phantom) is attached as previously described, and disposed in its position within the socket portion 9 of the trailer frame 11. There is also a lower ball 69 attached to the plate 48 as earlier described via the nut 49 engaging its stud 73, further fastened by nut 53 (FIG. 13). The nut 53 and the portion of the stud 73 are omitted from this view, for clarity in showing the position of the upper ball 67, but these elements are depicted clearly in FIG. 13. Thus, the lip portion 99 of the trailer frame 11 is seen to come into substantial close contact with the upper surface of the plate portion. Bolt 66 is shown disposed through hole 61 (FIG. 11), and is seen to be holding the bracers 81, 85 in position such that they hold the distal end of the trailer frame in a fixed position. Bolt 65 is shown disposed through hole 57 (FIG. 11), and is seen to be holding the bracers 77, 79 in position. Thus, bracers 77 and 85 provide an additional level of preventing substantial lateral movement of the distal end of the trailer with respect to the plate portion, and the bracers 79 and 81 provide an additional level of preventing vertical motion of the distal end of the trailer with respect to the plate portion. (Of course, the ball is still firmly engaged in the socket 9 and is only releasable by pulling on lock release lever 101, and such mechanisms including a lock release lever are well known in the art). Thus, one way to attach such a gender-altering assembly to an existing trailer frame, the device is placed into proximity of the distal end of a trailer such that the upper ball 67 engages the socket 9. Next, a stabilizing hardware assembly comprising bolt 66, stabilizers 81, 85, and nut 89 are paced into position and the nut and bolt 89 and 66 are tightened, thus causing the bracer 81 to clamp the lip portion 99 against the upper surface of the plate portion 48. Then, a stabilizing hardware assembly comprising bolt 65, stabilizers 79, 77, and nut 55 are paced into position and the nut and bolt 55 and 65 are tightened, thus causing the bracer 79 to clamp the lip portion 99 against the upper surface of the plate portion 48. This embodiment also includes an optional u-shaped channel 91, for imparting additional strength to a gender-altering assembly according to the present invention, as is shown further in FIG. 14 and FIG. 15.

In FIG. 13 is shown a right-side elevation view of a gender-altering assembly according to an alternate form of the invention with a trailer frame attached. In this figure are shown the respective positions of the plate portion 48, with the lower ball 69 attached thereto at its front portion via nuts 49 and 53 which are tightened against one another. Upper ball 67 is shown in phantom to be disposed within the socket portion of the trailer frame and connected to the plate portion by virtue of the engagement of the nut 51 with the threaded portion of the stud 75 that is disposed through the hole 47 (FIG. 10) in the plate portion 48. Also shown is the stabilizing hardware assembly which comprises bracers 77 and 79, held in a firm clamping position with respect to the lip portion 99 of the trailer frame by bolt 65 by nut 55.

In FIG. 14 is shown an underside perspective view of a gender-altering assembly according to an alternate form of the invention from a left viewpoint, which further comprises an optional stabilizing channel 91. In this view are shown the respective positions of the plate portion 48, bracers 85 and 81, nut 89, upper ball 67, lower ball 69, nuts 49 and 53, and tube 93. The tube 93 in this embodiment is hollow, and has an outer diameter which fits inside a corresponding hole within the lower ball 69. There is a hole 95 that is disposed through the walls of the tube 93, which enables attachment and detachment of the lower ball by insertion or removal of a pin that is commonly disposed through the lower ball 69 and the hole 95 in the tube 93, as such feature is well-known in the art, and sold by Convert-A-Ball Inc., of Sydney, Nebr. (http://www.convert-a-ball.com) Upper ball 67 is affixed rigidly to the plate by the nut 51 that is disposed about the threaded portion of the stud 75. The channel 91 has a u-shape in cross section, with the legs of the U shape being dimensioned so they are only slightly wider than the width of the nuts 49 and 51, so that the nuts 49 and 51 are prevented from turning by their engagement with the walls of the legs of the u-shaped channel. Thus, the studs/bolts which hold the upper ball 67 and lower ball 69 to the plate portion 48 are each disposed through both the plate portion 48 and the floor portion of the u-shaped channel 91. When the channel portion 91 is made of steel of at least 3 millimeters thickness, this arrangement provides added strength to the gender-altering assembly as a whole. The hollow tube portion 93 is preferably comprised of heavy steel as well, and is affixed to the stud 73 by conventional means, such as welding.

In FIG. 15 is shown an underside view of a gender-altering assembly according to the alternate form of the invention depicted in FIG. 14, showing the respective positions of the various elements, including the bolts 65 and 66, holes 59 and 63, nuts 49 and 51, channel 91, and lower ball 69. Leg portions of the channel 91 are shown as L1 and L2.

Thus, in an alternate form of the invention, the upper ball and lower ball do not have centerpoints which lie substantially on the same vertical axis drawn perpendicular to a road or other flat surface upon which a motorized vehicle and trailer rest, but rather, the vertical axis of the lower ball and the vertical axis of the upper ball are offset, with the vertical axis of the lower ball being closer to the front of the motorized vehicle (when the trailer is engaged to a trailer using a gender-altering assembly according to this embodiment) and the vertical axis being closer to the rear of the towed trailer.

The alternate embodiments of the gender-altering assembly as described herein are useful in all employments set forth for the earlier embodiment of the gender-altering device.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Further, when statements are made herein such as “according to the invention”, such statement in reality refers to a single possible embodiment of the invention, and such statements shall not be construed as being delimitive of the invention. Accordingly, the presently disclosed invention is intended to cover all such modifications and alterations, and is limited only by the scope of the claims which follow.

What is claimed is:

1) A device useful for coupling a motorized vehicle to a trailer which comprises a receiving portion comprising:
a) a floor portion having:
i) a trailer-receiving edge;
ii) a second edge; and
iii) a third edge,
b) a first wall portion having a proximal end and a distal end and a height dimension and being disposed along a substantial portion of the length of said second edge of said floor portion, and extending substantially perpendicularly upwards from said floor portion;
c) a second wall portion having a proximal end and a distal end and a height dimension, and being disposed along a substantial portion of the length of said third edge of said floor portion, and extending substantially perpendicularly upwards from said floor portion; and
d) a hole disposed in said floor portion, wherein said hole is adapted to receive a trailer ball.

2) A device according to claim 1 further comprising a means for securing a trailer ball within said hole disposed in said floor portion.

3) A device according to claim 1 wherein said hole is located within sufficient proximity of the point where said second edge intersects said third edge in space to enable said wall portions to effectively guide a laterally-moving trailer ball to become resident within said hole.

4) A device according to claim 1 wherein said hole is located in a position sufficient that a trailer ball in contact with said floor portion that is caused to travel towards the point at which said first wall portion and said second wall portion intersect in space will be guided by at least one of said wall portions to become resident within said hole.

5) A device according to claim 1, wherein said hole has a diameter having dimension D, and a centerpoint centrally located on said diameter, and wherein said centerpoint of said hole is located at a distance less than about 3D from the point at which said first wall portion and said second wall portion intersect in space.

6) A device according to claim 1, further comprising a vehicle tow bar, wherein said tow bar is attached to said receiving portion.

7) A device according to claim 1 wherein said floor portion is substantially planar.

8) A device according to claim 1 wherein said floor portion comprises a first sub-portion and a second sub-portion, wherein said sub-portions do not exist in the same plane.

9) A device according to claim 1 wherein said floor portion is provided with a lining on one or more of its outer surfaces.

10) A device according to claim 9 wherein said lining is comprised of a polymeric substance.

11) A device according to claim 1 wherein said floor portion is substantially triangular.

12) A device according to claim 1 wherein the height dimensions of said first wall portion and said second wall portions are identical to one another.

13) A device according to claim 1 wherein said distal ends of said first and said second wall portions are disposed with respect to one another so as to form an angle, which angle may be any angle in the range of between about 45 degrees and 135 degrees.

14) A device according to claim 1 wherein said trailer-receiving edge is linear.

15) A device according to claim 8 wherein said trailer-receiving edge comprises an angle, and wherein said floor portion comprises a partition, with the vertex of said angle being coincident with said partition.

16) A device useful for altering the gender of a trailer hitch, which device comprises:
a) a first ball portion existing substantially in the shape of a sphere and having a first bore hole having an inner wall and extending at least partially therethrough, said first bore including threads on its inner wall;
b) a second ball portion existing substantially in the shape of a sphere and having a second bore hole having an inner wall and extending at least partially therethrough, said second bore including threads on its inner wall;
c) a rod having a first end which includes threads on its outer surface and a second end which includes threads on its outer surface, and an outer diameter;
d) a strike plate, comprising a substantially planar sheet metal, further comprising a hole disposed through its entirety having a diameter that is large enough to enable said rod to pass therethrough; and
e) a nut having a threaded bore capable of cooperative disposition on said rod,
wherein said first ball portion is disposed on said first end of said rod and wherein said second ball portion is disposed on said second end of said rod by cooperation of the threads disposed on the rod ends and threads disposed within the bores within said ball portions, said strike plate being disposed on said rod at a location between said first ball portion and said second ball portion, and wherein said nut is disposed on said rod at a location between either of said ball portions and said strike plate.

17) A gender-modified trailer, comprising a conventional trailer having a “female” ball-receiving socket, which further comprises a device according to claim 16 with either of said first ball portion or said second ball portion being disposed in said ball-receiving socket, and the remaining ball portion being disposed beneath said socket.

18) A motorized vehicle comprising a device useful for coupling a motorized vehicle to a trailer which comprises a receiving portion comprising:
a) a floor portion having:
i) a trailer-receiving edge;
ii) a second edge; and
iii) a third edge,
b) a first wall portion having a proximal end and a distal end and a height dimension and being disposed along a substantial portion of the length of said second edge of said floor portion, and extending substantially perpendicularly upwards from said floor portion;
c) a second wall portion having a proximal end and a distal end and a height dimension, and being disposed along a substantial portion of the length of said third edge of said floor portion, and extending substantially perpendicularly upwards from said floor portion; and
d) a hole disposed in said floor portion, wherein said hole is adapted to receive a trailer ball,
said receiving portion being attached to the rear of said motorized vehicle.

19) A motorized vehicle according to claim 18 wherein said device is attached to the rear of said motorized vehicle via attachment to a conventional tow-bar-receiving fixture on said motorized vehicle.

20) A device useful for altering the gender of a trailer hitch, which device comprises:
a) a first ball portion existing substantially in the shape of a sphere and having a first diameter, said first ball further comprising a first linear stud having a threaded exterior portion, which first stud extends outwardly from a point inside said first ball, and which first stud includes a free end;
b) a second ball portion existing substantially in the shape of a sphere and having a second diameter, said second ball further comprising a second linear stud having a threaded exterior portion, which second stud extends outwardly from a point inside said second ball, and which second stud includes a free end;
c) a substantially planar plate portion having an upper surface, a lower surface, and a plurality of holes disposed therethrough, wherein said plurality of holes are of a smaller diameter than the diameter of said ball portions;
d) a linear channel, having a substantially u-shaped cross section and including a floor portion and two leg portions, said channel portion comprising two holes disposed through its floor portion, wherein said two holes are sufficiently spaced from one another to correspond to the distance between two of said plurality of holes on said plate portion,
said floor portion of said channel being in substantial contact with the lower surface of said plate portion, with said first linear stud of said first ball portion passing through a one of said holes in said plate portion and a first hole in the floor portion of said channel, and with said second linear stud of said second ball portion passing through another of said holes through said plate portion and a second hole in the floor portion of said channel, such that said first ball portion is disposed above the upper surface of said plate portion and such that said second ball portion is disposed beneath the lower surface of said plate portion, with the first ball portion being secured in position by means of a fastening means disposed on said free end of said first linear stud, and with the second ball portion being secured in position by means of a fastening means disposed on said free end of said second linear stud.

21) A device according to claim 20 wherein said first linear stud comprises a threaded exterior portion.

22) A device according to claim 21 wherein said second linear stud comprises a threaded exterior portion.

23) A device according to claim 22 wherein each of said fastening means comprises a nut on the threaded exterior portion of each of said studs.

24) A device according to claim 20 further comprising: e) a plurality of clamping means attached to said plate portion, said clamping means comprising at least one bored metal plate disposed about a bolt, which bolt is disposed through a hole in said plate portion and fastened in position by means of a nut.

25) A gender-modified trailer, comprising a conventional trailer having a “female” ball-receiving socket, and a device according to claim 20 with at least one of said first ball portion and said second ball portion being disposed in said ball-receiving socket.

26) A system for enabling easy coupling of a motorized vehicle to a trailer which comprises:
I.) a gender-modified trailer, comprising a conventional trailer having a “female” ball-receiving socket, which further comprises a device useful for altering the gender of a trailer hitch, which device comprises:
a) a first ball portion existing substantially in the shape of a sphere and having a first diameter, said first ball further comprising a first linear stud having a threaded exterior portion, which first stud extends outwardly from a point inside said first ball, and which first stud includes a free end;
b) a second ball portion existing substantially in the shape of a sphere and having a second diameter, said second ball further comprising a second linear stud having a threaded exterior portion, which second stud extends outwardly from a point inside said second ball, and which second stud includes a free end;
c) a substantially planar plate portion having an upper surface, a lower surface, and a plurality of holes disposed therethrough, wherein said plurality of holes are of a smaller diameter than the diameter of said ball portions;
d) a linear channel, having a substantially u-shaped cross section and including a floor portion and two leg portions, said channel portion comprising two holes disposed through its floor portion, wherein said two holes are sufficiently spaced from one another to correspond to the distance between two of said plurality of holes on said plate portion,
said floor portion of said channel being in substantial contact with the lower surface of said plate portion, with said first linear stud of said first ball portion passing through a one of said holes in said plate portion and a first hole in the floor portion of said channel, and with said second linear stud of said second ball portion passing through another of said holes through said plate portion and a second hole in the floor portion of said channel, such that said first ball portion is disposed above the upper surface of said plate portion and such that said second ball portion is disposed beneath the lower surface of said plate portion, with the first ball portion being secured in position by means of a fastening means disposed on said free end of said first linear stud, and with the second ball portion being secured in position by means of a fastening means disposed on said free end of said second linear stud, wherein either of said first ball portion or said second ball portion is disposed in said ball-receiving socket; and
II.) a motorized vehicle comprising a coupling device useful for coupling a motorized vehicle to a trailer which comprises a receiving portion comprising:
a) a floor portion having:
i) a trailer-receiving edge;
ii) a second edge; and
iii) a third edge,
b) a first wall portion having a proximal end and a distal end and a height dimension and being disposed along a substantial portion of the length of said second edge of said floor portion, and extending substantially perpendicularly upwards from said floor portion;
c) a second wall portion having a proximal end and a distal end and a height dimension, and being disposed along a substantial portion of the length of said third edge of said floor portion, and extending substantially perpendicularly upwards from said floor portion; and
d) a hole disposed in said floor portion, wherein said hole is adapted to receive a trailer ball,
wherein said coupling device is attached to the rear of said motorized vehicle, and wherein said second ball portion disposed beneath the lower surface of said plate portion on said gender-modified trailer is located within said hole disposed in said floor portion of said coupling device.
